(19) United States
(12) Patent Application Publication
(10) Pub. No.: US 2017/0336969 A1
(43) Pub. Date: Nov. 23, 2017

(54) PREDICTING NEXT LETTERS AND DISPLAYING THEM WITHIN KEYS OF A GRAPHICAL KEYBOARD

(71) Applicant: Google Inc., Mountain View, CA (US)

(72) Inventor: Xiaojun Bi, Sunnyvale, CA (US)

(21) Appl. No.: 15/157,229

(22) Filed: May 17, 2016

(51) Int. Cl. G06F 3/0488; G06F 17/27

(52) U.S. Cl. CPC G06F 3/04886; G06F 3/04883; G06F 17/276

(57) ABSTRACT

A computing device is described that outputs, for display, a graphical keyboard including a set of keys. The set of keys includes a first key that is associated with a first character. The computing device determines a candidate word that includes the first character and determines a score associated with the candidate word that indicates a probability of the candidate word being entered by one or more subsequent selections of one or more of the set of keys. In response to determining that the score associated with the candidate word satisfies a threshold, the computing device determines, based on a spelling of the candidate word, a second character of the candidate word and outputs, for display within the first key, a graphical indication of the first character and a graphical indication of the second character.

### BACKGROUND

Some computing devices (e.g., mobile phones, tablet computers, etc.) may provide a graphical keyboard as part of a graphical user interface (“GUI”) for composing text using a presence-sensitive display (e.g., a touchscreen). The graphical keyboard may enable a user of the computing device to enter text (e.g., to compose an e-mail, a text message, a document, etc.). For instance, a presence-sensitive display of a computing device may present a graphical (or “soft”) keyboard that enables the user to enter data by indicating (e.g., by tapping or swiping across) keys displayed at the presence-sensitive display. To assist a user in providing text entry at a graphical keyboard, some computing devices may provide word suggestions or spelling and grammar corrections in a suggestion region of the graphical keyboard that is separate from the area of the display in which the graphical keys of the keyboard are displayed. In some instances, a given set of word suggestions may not be useful or relevant. If a given one of the suggested words is in fact useful or relevant, a user may be required to cease typing at the keys of the graphical keyboard, review the suggested words, and then provide additional input at the suggestion region to select the given the suggested word. This sequence of steps thereby results in a degree of inefficiency during user entry of text via a presence-sensitive display.

### SUMMARY

In one example, a method includes outputting, by a computing device, for display, a graphical keyboard including a plurality of keys, determining, by the computing device, at least one candidate word that includes the first character, and determining, by the computing device, a score associated with the at least one candidate word that indicates a probability of the at least one candidate word being entered by one or more subsequent selections of one or more of the plurality of keys. The plurality of keys includes a first key that is associated with a first character. The method further includes, responsive to determining that the score associated with the at least one candidate word satisfies a threshold, determining, by the computing device, based on a spelling of the at least one candidate word, a second character of the at least one candidate word and outputting, by the computing device, for display within the first key, a graphical indication of the first character and a graphical indication of the second character. The second character immediately follows the first character in the spelling of the at least one candidate word.

In another example, a device includes a presence-sensitive display, at least one processor, and a memory. The graphical keyboard includes a plurality of keys. The plurality of keys include a first key that is associated with a first character. The memory stores instructions that, when executed by the at least one processor, cause the at least one processor to output, for display at the presence-sensitive display, a graphical keyboard, determine at least one candidate word that includes the first character, and determine a score associated with the at least one candidate word that indicates a probability of the at least one candidate word being entered by one or more subsequent selections of one or more of the plurality of keys. The memory stores instructions that, when executed by the at least one processor, further cause the at least one processor to, responsive to determining that the score associated with the at least one candidate word satisfies a threshold, determine, based on a spelling of the at least one candidate word, a second character of the at least one candidate word, and output, for display within the first key, a graphical indication of the first character and a graphical indication of the second character. The second character immediately follows the first character in the spelling of the at least one candidate word.

In another example, a computer-readable storage medium is encoded with instructions that, when executed, cause at least one processor of a computing device to output, for display, a graphical keyboard, determine at least one candidate word that includes the first character, and determine a score associated with the at least one candidate word that indicates a probability of the at least one candidate word being entered by one or more subsequent selections of one or more of the plurality of keys. The instructions, when executed, further cause the at least one processor to, responsive to determining that the score associated with the at least one candidate word satisfies a threshold, determine, based on a spelling of the at least one candidate word, a second character of the at least one candidate word, and output, for display within the first key, a graphical indication of the first character and a graphical indication of the second character. The second character immediately follows the first character in the spelling of the at least one candidate word.

The details of one or more examples of the disclosure are set forth in the accompanying drawings and the description below. Other features, objects, and advantages will be apparent from the description and drawings, and from the claims.

### BRIEF DESCRIPTION OF DRAWINGS

FIGS. 1A-1C are conceptual diagrams illustrating an example computing device that may be used to predict next letters and display them within keys of a graphical keyboard, in accordance with one or more techniques of the present disclosure.

FIG. 2 is a block diagram illustrating further details of one example of a computing device as shown in FIG. 1A, in accordance with one or more techniques of the present disclosure.

FIG. 3 is a conceptual diagram illustrating an example computing device that outputs graphical content for display at a remote device, in accordance with one or more techniques of the present disclosure.

FIGS. 4A-4B are conceptual diagrams illustrating further details of a first example of a computing device shown in FIG. 1A, in accordance with one or more techniques of the present disclosure.

FIGS. 5A-5B are conceptual diagrams illustrating further details of a second example of a computing device shown in FIG. 1A, in accordance with one or more techniques of the present disclosure.

FIGS. 6A-6B are conceptual diagrams illustrating further details of a third example of a computing device shown in FIG. 1A, in accordance with one or more techniques of the present disclosure.

FIG. 7 is a flow diagram illustrating example operations of an example computing device configured to predict next letters and display them within keys of a graphical keyboard, in accordance with one or more techniques of the present disclosure.

### DETAILED DESCRIPTION

In general, this disclosure is directed to techniques for enabling a computing device to display, within a single key of a graphical keyboard, two or more next letters that the device predicts will be selected from a subsequent input at the graphical keyboard. In other words, the computing device may display selectable parts of suggested words (e.g., two or more letters) within the keys that the user is already providing input. For instance, an example computing device may display within a first key of a graphical keyboard, a letter that is typically associated with the first key, along with a next letter that is typically associated with a different key that is predicted to be selected after selecting the first key. In response to receiving an indication of a selection of the first key, the computing device may determine a selection of both letters being displayed within the first key. For example, to spell the word “That” the computing device may receive a first user input selecting “Th” and a second user input selecting “at” rather than four independent user inputs that spell each letter of the word “that.”

Rather than requiring the user to search through, and provide inputs to select whole suggested words that are displayed within a separate suggestion region of the graphical keyboard, the computing device may display two or more next letters of one or more suggested words within individual keys of the graphical keyboard. By displaying parts of suggested words, as opposed to whole suggested words, within the keys of a graphical keyboard, an example computing device may provide more useful and relevant suggestions to a user because the computing device is more likely to correctly predict one or more next letters that are likely to be selected, rather than predicting all the letters of an entire suggested word. In addition, by providing a graphical keyboard with next letter prediction, entirely within the keys of the graphical keyboard, a user need not provide input at a separate region of the keyboard that is distinct from the graphical keys, thereby enabling quicker word entry, using fewer inputs. In this way, techniques of this disclosure may reduce the time a user spends to enter a desired word, which may improve the user experience of a computing device.

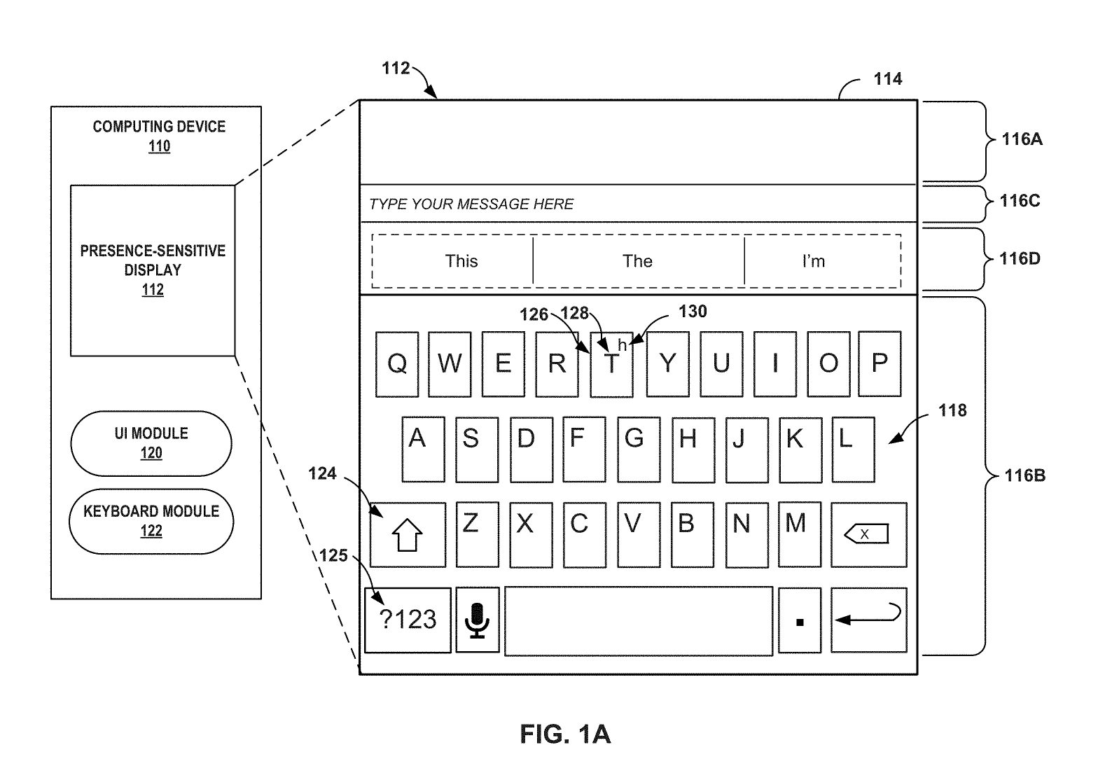

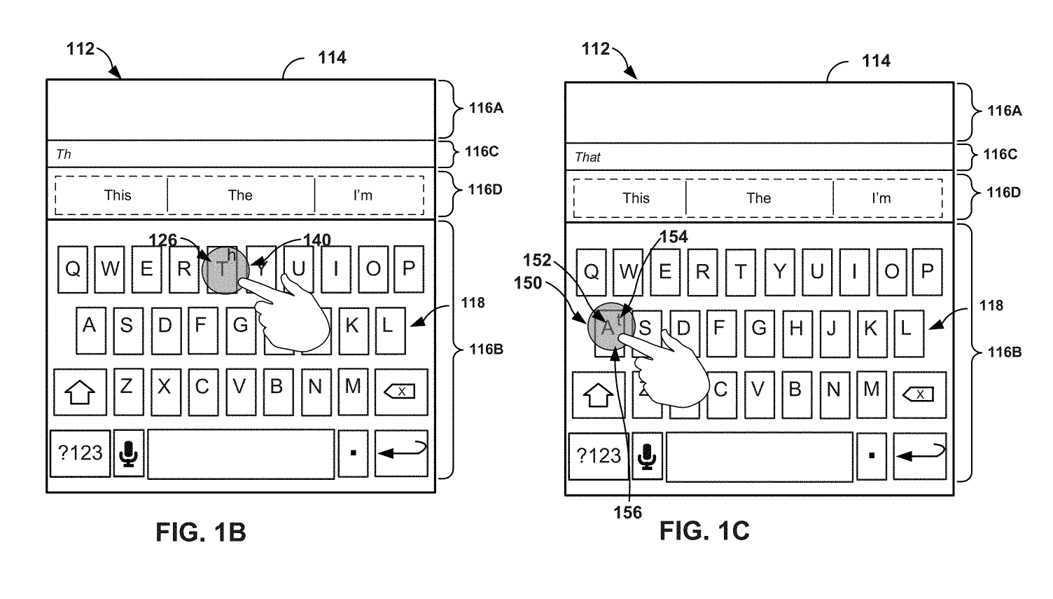

FIGS. 1A-C are conceptual diagrams illustrating an example computing device that may be used to predict next letters and display them within keys of a graphical keyboard, in accordance with one or more techniques of the present disclosure. Computing device 110 may represent a mobile device, such as a smart phone, a tablet computer, a laptop computer, computerized watch, computerized eyewear, computerized gloves, or any other type of portable computing device. Additional examples of computing device 110 include desktop computers, televisions, personal digital assistants (PDA), portable gaming systems, media players, e-book readers, mobile television platforms, automobile navigation and entertainment systems, vehicle (e.g., automobile, aircraft, or other vehicle) cockpit displays, or any other types of wearable and non-wearable, mobile or non-mobile computing devices that may output a graphical keyboard for display.

Computing device 110 includes a presence-sensitive display (PSD) 112, user interface (UI) module 120 and keyboard module 122. Modules 120 and 122 may perform operations described using software, hardware, firmware, or a mixture of hardware, software, and firmware residing in and/or executing at computing device 110. One or more processors of computing device 110 may execute instructions that are stored at a memory or other non-transitory storage medium of computing device 110 to perform the operations of modules 120 and 122. Computing device 110 may execute modules 120 and 122 as virtual machines executing on underlying hardware. Modules 120 and 122 may execute as one or more services of an operating system or computing platform. Modules 120 and 122 may execute as one or more executable programs at an application layer of a computing platform.

PSD 112 of computing device 110 may function as respective input and/or output devices for computing device 110. PSD 112 may be implemented using various technologies. For instance, PSD 112 may function as input devices using presence-sensitive input screens, such as resistive touchscreens, surface acoustic wave touchscreens, capacitive touchscreens, projective capacitance touchscreens, pressure sensitive screens, acoustic pulse recognition touchscreens, or another presence-sensitive display technology. PSD 112 may also function as output (e.g., display) devices using any one or more display devices, such as liquid crystal displays (LCD), dot matrix displays, light emitting diode (LED) displays, organic light-emitting diode (OLED) displays, e-ink, or similar monochrome or color displays capable of outputting visible information to a user of computing device 110.

PSD 112 may detect input (e.g., touch and non-touch input) from a user of respective computing device 110. PSD 112 may detect indications of input by detecting one or more gestures from a user (e.g., the user touching, pointing, and/or swiping at or near one or more locations of PSD 112 with a finger or a stylus pen). PSD 112 may output information to a user in the form of user interface (e.g., user interface 114), which may be associated with functionality provided by computing device 110. Such user interfaces may be associated with computing platforms, operating systems, applications, and/or services executing at or accessible from computing device 110 (e.g., electronic message applications, chat applications, Internet browser applications, mobile or desktop operating systems, social media applications, electronic games, and other types of applications). For example, PSD 112 may present user interface 114 which, as shown in FIGS. 1A-IC, may be a graphical user interfaces of a chat application executing at computing device 110 and includes various graphical elements displayed at various locations of PSD 112.

As shown in FIGS. 1A-C, user interface 114 is part of a chat user interface, however user interface 114 may be any graphical user interface which includes a graphical keyboard. User interface 114 includes output region 116A, graphical keyboard 116B, edit region 116C, and suggestion region 116D. A user of computing device 110 may provide input at graphical keyboard 116B to produce textual characters within edit region 116C that form the content of the electronic messages displayed within output region 116A. The messages displayed within output region 116A form a chat conversation between a user of computing device 110 and a user of a different computing device.

UI module 120 manages user interactions with PSD 112 and other components of computing device 110. In other words, UI module 120 may act as an intermediary between various components of computing device 110 to make determinations based on user input detected by PSD 112 and generate output at PSD 112 in response to the user input. UI module 120 may receive instructions from an application, service, platform, or other module of computing device 110 to cause PSD 112 to output a user interface (e.g., user interface 114). UI module 120 may manage inputs received by computing device 110 as a user views and interacts with the user interface presented at PSD 112 and update the user interface in response to receiving additional instructions from the application, service, platform, or other module of computing device 110 that is processing the user input.

Keyboard module 122 of computing device 110 may perform traditional, graphical keyboard operations used for text-entry, such as: generating a graphical keyboard layout for display at PSD 112, mapping detected inputs at PSD 112 to selections of keys, determining characters based on selected keys, or predicting or autocorrecting words and/or phrases based on the characters determined from selected keys. Keyboard module 122 may be a stand-alone application, service, or module executing at computing device 110 and in other examples, keyboard module 122 may be a sub-component thereof. For example, keyboard module 122 may be integrated into a chat or messaging application executing at computing device 110 whereas in other examples, keyboard module 122 may be a stand-alone application or subroutine that is invoked by an application or operating platform of computing device 110 any time an application or operating platform requires graphical keyboard input functionality. In some examples, computing device 110 may download and install keyboard module 122 from an application repository of a service provider (e.g., via the Internet). In other examples, keyboard module 122 may be preloaded during production of computing device 110.

Graphical keyboard 116B includes graphical keys 118 and suggested words displayed in suggestion region 116D. Suggested words displayed in suggestion region 116D may be determined by computing device 110 based on a history log, lexicon, or the like. Each one of keys 118 may typically represent a single character from a character set (e.g., letters of the English alphabet, Arabic numerals, symbols, emoticons, emoji, or the like). As shown in FIG. 1A, graphical keyboard 116B may include a traditional “QWERTY” keyboard layout. Other examples may contain characters for different languages, different character sets, or different character layouts. In some examples, graphical keyboard 116B may include each letter in an alphabet of a selected language. For instance, as shown, graphical keyboard 116B includes 26 letters for the English language. In some examples, graphical keyboard 116 may include a partial set of letters. As shown, graphical keyboard 116B may include upper case selector key 124 that changes a case of letters displayed in graphical keyboard 116B. In some examples, graphical keyboard 116B may include one or more keys that change keys 118 displayed in graphical keyboard 116B. For instance, graphical keyboard 116B may include numeric key 125 that when selected may cause graphical keyboard 116B to display numbers rather than letters.

Keyboard module 122 may output information to UI module 120 that specifies the layout of graphical keyboard 116B within user interface 114. For example, the information may include instructions that specify locations, sizes, colors, and other characteristics of keys 118. Based on the information received from keyboard module 122, UI module 120 may cause PSD 112 to display graphical keyboard 116B as part of user interface 114.

At least some of keys 118 may be associated with individual characters (e.g., a letter, number, punctuation, or other character). A user of computing device 110 may provide input at locations of PSD 112 at which one or more of keys 118 are displayed to input content (e.g., characters, etc.) into edit region 116C (e.g., for composing messages that are sent and displayed within output region 116A). Keyboard module 122 may receive information from UI module 120 indicating locations associated with input detected by PSD 112 that are relative to the locations of each of the keys. Using a spatial and/or language model, keyboard module 122 may translate the inputs to selections of keys and characters, words, phrases, or other phrases.

For example, PSD 112 may detect user inputs as a user of computing device 110 provides user inputs at or near a location of PSD 112 where PSD 112 presents keys 118. UI module 120 may receive, from PSD 112, an indication of the user input at PSD 112 and output, to keyboard module 122, information about the user input. Information about the user input may include an indication of one or more touch events (e.g., locations and other information about the input) detected by PSD 112.

Based on the information received form UI module 120, keyboard module 122 may map detected inputs at PSD 112 to selections of keys 118, determine characters based on selected keys 118, and predict or autocorrect words and/or phrases determined based on the characters associated with the selected keys 118. For example, keyboard module 122 may include a spatial model that may determine, based on the locations of keys 118 and the information about the input, the most likely one or more keys 118 being selected. Responsive to determining the most likely one or more keys 118 being selected, keyboard module 122 may determine one or more characters, words, and/or phrases. For example, each of the one or more keys 118 being selected from a user input at PSD 112 may represent either an individual character or a combination including the character associated with the key and a second character of a candidate word. Keyboard module 122 may determine a sequence of characters selected based on the one or more selected keys 118. In some examples, keyboard module 122 may apply a language model to the sequence of characters to determine one or more the most likely candidate letters, morphemes, words, and/or phrases that a user is trying to input based on the selection of keys 118.

Keyboard module 122 may send the sequence of characters and/or candidate words and phrases to UI module 120 and UI module 120 may cause PSD 112 to present the characters and/or candidate words determined from a selection of one or more keys 118 as text within edit region 116C. In some examples, when functioning as a traditional keyboard for performing text-entry operations, and in response to receiving a user input at keys 118 (e.g., as a user is typing at graphical keyboard 116B to enter text within edit region 116C), keyboard module 122 may cause UI module 120 to display the candidate words as one or more selectable suggestions within suggestion region 116D. A user can select an individual suggestion within suggestion region 116D rather than type all the individual character keys of keys 118.

Rather than simply displaying word suggestions within edit region 116C or suggestion region 116D, keyboard module 122 may cause UI module 120 to display predicted next letters that are likely to be selected from future user input within the graphical representations of one or more of keys 118. For example, keyboard module 122 may output, for display, graphical keyboard 116B which, as shown in FIG. 1A, includes key 126 that is associated with a first character (e.g., ‘t’) as one of keys 118.

Keyboard module 122 may determine (e.g., from a lexicon) at least one candidate word or words that include the first character associated with key 126. For example, keyboard module 122 may input the first character into a lexicon and in response, receive an indication of one or more candidate characters, words, or phrases that keyboard module 122 identifies from the lexicon as being potential words that include the first character. For instance, responsive to inputting the first character (e.g., ‘t’) that is associated with key 126 into the lexicon, keyboard module 122 may receive, from the lexicon, an indication of the words “This,” “The,” and “That.”

In response to determining the at least one candidate word that includes the first character, keyboard module 122 may determine a score associated with the at least one candidate word that indicates a probability of the at least one candidate word being selected during a subsequent selection of one or more of keys 118. For example, keyboard module 122 may assign a language model probability or a similarity coefficient (e.g., a Jaccard similarity coefficient) to the one or more candidate words, received from the lexicon of computing device 110, that include the first character as the next inputted character. In some examples, keyboard module 122 may compute the score of each candidate word using a language model. And in some examples, keyboard module 122 may receive an indication of the score associated with each candidate word from the lexicon. In any case, the score or language model probability assigned to each of the one or more candidate words may indicate a degree of certainty or a degree of likelihood that the candidate word is typically found positioned subsequent to, prior to, and/or within, a sequence of words (e.g., a sentence) generated from text input detected by PSD 112.

In response to determining the score associated with the at least one candidate word that indicates a probability of the at least one candidate word being selected during a subsequent selection of one or more of keys 118, keyboard module 122 may determine whether the score associated with the at least one candidate word satisfies a threshold. The threshold may be a predetermined value selected by a manufacturer of computing device 110, by a designer of UI module 120, by a designer of keyboard module 122, by a user of computing device 110, or selected by another person. In some examples, the threshold may be computed. For instance, the threshold may be computed by computing device 110 based on a history log of user interactions with computing device 110.

In response to determining that the score associated with the at least one candidate word does not satisfy the threshold, keyboard module 122 may output, for display within key 126, a graphical indication of the first character and refrain from outputting a graphical indication of a second character. For instance, keyboard module 122 may send information to UI module 120 that causes PSD 112 to display key 126 as having graphical indication 128 of the first character as the letter ‘t’ and to refrain from outputting graphical indication 130 of the second character as the letter ‘h.’

In response to determining that the score associated with the at least one candidate word satisfies the threshold, keyboard module 122 may determine a second character of the at least one candidate word. In some examples, keyboard module 122 may determine the second character of the at least one candidate word based on a spelling of the at least one candidate word. For instance, in response to determining that the candidate word is “that”, keyboard module 122 may determine the first letter to be “t” and the second character to be “h”. More specifically, keyboard module 122 may determine the second character to be the character that immediately follows the first character in the spelling of the at least one candidate word.

In response to determining the second character of the at least one candidate word, keyboard module 122 may output, for display within key 126, a graphical indication of the first character and a graphical indication of the second character. In the example of FIG. 1A, keyboard module 122 may send information to UI module 120 that causes PSD 112 to display key 126 as having graphical indication 128 of the first character as the letter ‘t’ and as also having graphical indication 130 of the second character as the letter ‘h.’

After outputting the graphical indication 128 of the first character and the graphical indication 130 of the second character, keyboard module 122 may receive an indication of a selection of key 126. For example, keyboard module 122 may receive information from UI module 120 indicating a user has provided user input 140 at or near a location of PSD 112 at which key 126 is displayed.

In response to receiving an indication of user input 140, keyboard module 122 may determine whether user input 140 corresponds to a selection of the first character alone or a selection of a combination of the first character and the second character, for instance, the first character followed by the second character. In the example of FIG. 1B, keyboard module 122 may determine whether user input 140 corresponds to the first character alone (e.g., the letter ‘t’) or a combination including the first character and the second character (e.g., the phrase ‘th’) based on a quantity of taps (e.g., different touch down and touch up events) associated with user input 140, a swipe direction associated with user input 140, an amount of pressure associated with user input 140, or another characteristic or parameter associated with a selection of key 126.

In response to determining user input 140 does not correspond to a selection of a combination of the first character and the second character, keyboard module 122 may cause UI module 120 to output, for display, the first character (e.g., the letter ‘t’) alone and refrain from outputting the second character (e.g., the letter ‘h’) to PSD 112.

In response to determining user input 140 corresponds to a selection of a combination of the first character and the second character, keyboard module 122 may cause UI module 120 to output, for display, the combination including the first character and the second character (e.g., the phrase ‘th’) to PSD 112. As shown in FIG. 1B, in response, PSD 112 displays the combination including the first character and the second character as text in edit region 116C.

Keyboard module 122 may repeat one or more operations as described above. For example, keyboard module 122 may determine a phrase (e.g., Tha’) based on the previous selection of the combination including the first character and the second character (e.g., the phrase ‘Th’) as well as the letter associated with key 150 (e.g., ‘a’) and input the phrase into a lexicon and, in response, receive an indication of the word “That.” As shown in FIG. 1C, keyboard module 122 may cause UI module 120 to display at PSD 112, and within key 150, a graphical indication 152 of a character associated with key 150 (e.g., the letter ‘a’) and a graphical indication 154 of a predicted next letter (e.g., the letter ‘t’) that is determined based on the suggested word “that.”

In response to keyboard module 122 determining that user input 150 corresponds to the combination including the character associated with key 150 and the predicted next letter, keyboard module 122 may cause UI module 120 to output, for display, the combination including the character associated with key 150 and the predicted next letter (e.g., the phrase ‘at) to PSD 112. As shown in FIG. 1C, in response, PSD 112 displays suggested word “that” as text in edit region 116C.

By displaying predicted next letters within keys of a graphical keyboard, an example computing device, such as computing device 110, may provide suggestions that are more useful and relevant since, rather than displaying an entire word, the example computing device displays a portion (e.g., two or more characters) of a suggested word at a time. Moreover, since the example computing device displays of the predicted portion a suggested word within keys of a graphical keyboard, a user of the example computing device may easily find and select predicated letters, rather than requiring the user to navigate away from the keys and wade through a separate suggestion region to search for and select a desired word. In this way, techniques of this disclosure may improve a user experience with the example computing device by reducing the amount of time a user is searching for and selecting predicted letters, as well as reducing the number of user inputs required by a computing device to type a word.

Although the previous examples applied to the A key and the T key, such examples may substantially apply to any key of graphical keyboard 116B. Further, although the examples shown in FIGS. 1A-C, describe techniques that are applied to a single key at a time (e.g., key 126 in FIG. 1B, key 150 in FIG. 1C), such examples may be substantially applied simultaneously on multiple keys 118 of graphical keyboard 116B. Additionally, although the previous examples show PSD 112 displaying graphical indications of a predicted next letter in an upper right region of a key, the predicted next letters may be positioned in any suitable region within a key, for instance, in the lower left corner, upper left corner, lower right corner, or another region within a key.

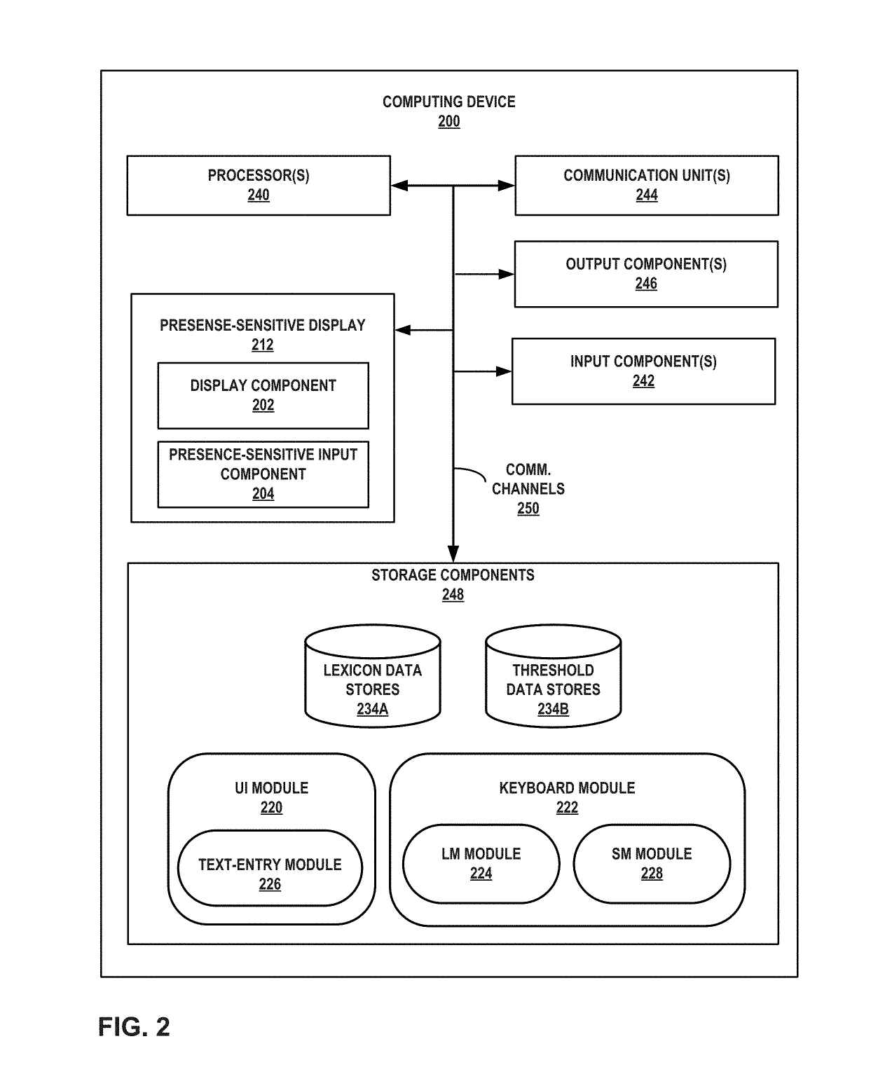

FIG. 2 is a block diagram illustrating further details of one example of computing device 110 as shown in FIG. 1A, in accordance with one or more techniques of the present disclosure. Computing device 200 of FIG. 2 is described below within the context of computing device 110 of FIG. 1A. Computing device 200 of FIG. 2 in some examples represents an example of computing device 110 of FIG. 1A. FIG. 2 illustrates only one particular example of computing device 200, and many other examples of computing device 200 may be used in other instances and may include a subset of the components included in example computing device 200 or may include additional components not shown in FIG. 2.

As shown in the example of FIG. 2, computing device 200 includes presence-sensitive display 212, one or more processors 240, one or more input components 242, one or more communication units 244, one or more output components 246, and one or more storage components 248. Presence-sensitive display 212 includes display component 202 and presence-sensitive input component 204.

One or more storage components 248 of computing device 200 are configured to store UI module 220 and keyboard module 222. UI module 220 includes text-entry module 226 and keyboard module 222 includes language model (LM) module 224 and spatial model (SM) module 228. Additionally, storage components 248 are configured to store lexicon data stores 234A and threshold data stores 234B. Collectively, data stores 234A and 234B may be referred to herein as “data stores 234”.

Communication channels 250 may interconnect each of the components 202, 204, 212, 240, 242, 244, 246, and 248 for inter-component communications (physically, communicatively, and/or operatively). In some examples, communication channels 250 may include a system bus, a network connection, an inter-process communication data structure, or any other method for communicating data.

One or more input components 242 of computing device 200 may receive input. Examples of input are tactile, audio, image and video input. Input components 242 of computing device 200, in one example, includes a presence-sensitive display, touch-sensitive screen, mouse, keyboard, voice responsive system, a microphone or any other type of device for detecting input from a human or machine. In some examples, input components 242 include one or more sensor components such as one or more location sensors (GPS components, Wi-Fi components, cellular components), one or more temperature sensors, one or more movement sensors (e.g., accelerometers, gyros), one or more pressure sensors (e.g., barometer), one or more ambient light sensors, and one or more other sensors (e.g., microphone, a still camera, a video camera, a body camera, eyewear, or other camera device that is operatively coupled to computing device 200, infrared proximity sensor, hygrometer, and the like).

One or more output components 246 of computing device 200 may generate output. Examples of output are tactile, audio, still image and video output. Output components 246 of computing device 200, in one example, includes a presence-sensitive display, sound card, video graphics adapter card, speaker, cathode ray tube (CRT) monitor, liquid crystal display (LCD), or any other type of device for generating output to a human or machine.

One or more communication units 244 of computing device 200 may communicate with external devices via one or more wired and/or wireless networks by transmitting and/or receiving network signals on the one or more networks. For example, communication units 244 may be configured to communicate over a network with a remote computing system for displaying parts of suggested words within the keys of a graphical keyboard. Modules 220 and/or 222 may receive, via communication units 244, from the remote computing system, an indication of a character sequence in response to outputting, via communication unit 244, for transmission to the remote computing system, an indication of a sequence of touch events. Examples of communication unit 244 include a network interface card (e.g. such as an Ethernet card), an optical transceiver, a radio frequency transceiver, a GPS receiver, or any other type of device that can send and/or receive information. Other examples of communication units 244 may include short wave radios, cellular data radios, wireless network radios, as well as universal serial bus (USB) controllers.

Presence-sensitive display 212 of computing device 200 includes display component 202 and presence-sensitive input component 204. Display component 202 may be a screen at which information is displayed by presence-sensitive display 212 and presence-sensitive input component 204 may detect an object at and/or near display component 202. As one example range, presence-sensitive input component 204 may detect an object, such as a finger or stylus that is within two inches or less of display component 202. Presence-sensitive input component 204 may determine a location (e.g., an [x, y] coordinate) of display component 202 at which the object was detected. In another example range, presence-sensitive input component 204 may detect an object six inches or less from display component 202 and other ranges are also possible. Presence-sensitive input component 204 may determine the location of display component 202 selected by a user's finger using capacitive, inductive, and/or optical recognition techniques. In some examples, presence-sensitive input component 204 also provides output to a user using tactile, audio, or video stimuli as described with respect to display component 202. In the example of FIG. 2, presence-sensitive display 212 may present a user interface (such as a graphical user interface for displaying parts of suggested words within the keys of a graphical keyboard as shown in FIGS. 1A-C).

While illustrated as an internal component of computing device 200, presence-sensitive display 212 may also represent and an external component that shares a data path with computing device 200 for transmitting and/or receiving input and output. For instance, in one example, presence-sensitive display 212 represents a built-in component of computing device 200 located within and physically connected to the external packaging of computing device 200 (e.g., a screen on a mobile phone). In another example, presence-sensitive display 212 represents an external component of computing device 200 located outside and physically separated from the packaging or housing of computing device 200 (e.g., a monitor, a projector, etc. that shares a wired and/or wireless data path with computing device 200).

Presence-sensitive display 212 of computing device 200 may receive tactile input from a user of computing device 200. Presence-sensitive display 212 may receive indications of the tactile input by detecting one or more tap or non-tap gestures from a user of computing device 200 (e.g., the user touching or pointing to one or more locations of presence-sensitive display 212 with a finger or a stylus pen). Presence-sensitive display 212 may present output to a user. Presence-sensitive display 212 may present the output as a graphical user interface (e.g., edit region of 116C of FIGS. 1A-C), which may be associated with functionality provided by various functionality of computing device 200. For example, presence-sensitive display 212 may present various user interfaces of components of a computing platform, operating system, applications, or services executing at or accessible by computing device 200 (e.g., an electronic message application, a navigation application, an Internet browser application, a mobile operating system, etc.). A user may interact with a respective user interface to cause computing device 200 to perform operations relating to one or more the various functions. For example, UI module 220 may cause presence-sensitive display 212 to present a graphical user interface associated with a text input function of computing device 200. The user of computing device 200 may view output presented as feedback associated with the text input function and provide input to presence-sensitive display 212 to compose additional text using the text input function.

Presence-sensitive display 212 of computing device 200 may detect two-dimensional and/or three-dimensional gestures as input from a user of computing device 200. For instance, a sensor of presence-sensitive display 212 may detect a user's movement (e.g., moving a hand, an arm, a pen, a stylus, etc.) within a threshold distance of the sensor of presence-sensitive display 212. Presence-sensitive display 212 may determine a two or three dimensional vector representation of the movement and correlate the vector representation to a gesture input (e.g., a hand-wave, a pinch, a clap, a pen stroke, etc.) that has multiple dimensions. In other words, presence-sensitive display 212 can detect a multi-dimension gesture without requiring the user to gesture at or near a screen or surface at which presence-sensitive display 212 outputs information for display. Instead, presence-sensitive display 212 can detect a multi-dimensional gesture performed at or near a sensor which may or may not be located near the screen or surface at which presence-sensitive display 212 outputs information for display.

One or more processors 240 may implement functionality and/or execute instructions associated with computing device 200. Examples of processors 240 include application processors, display controllers, auxiliary processors, one or more sensor hubs, and any other hardware configure to function as a processor, a processing unit, or a processing device. Modules 220, 222, 224, 226, and 228 may be operable by processors 240 to perform various actions, operations, or functions of computing device 200. For example, processors 240 of computing device 200 may retrieve and execute instructions stored by storage components 248 that cause processors 240 to perform the operations modules 220, 222, 224, 226, and 228. The instructions, when executed by processors 240, may cause computing device 200 to store information within storage components 248.

One or more storage components 248 within computing device 200 may store information for processing during operation of computing device 200 (e.g., computing device 200 may store data accessed by modules 220, 222, 224, 226, and 228 during execution at computing device 200). In some examples, storage component 248 is a temporary memory, meaning that a primary purpose of storage component 248 is not long-term storage. Storage components 248 on computing device 200 may be configured for short-term storage of information as volatile memory and therefore not retain stored contents if powered off. Examples of volatile memories include random access memories (RAM), dynamic random access memories (DRAM), static random access memories (SRAM), and other forms of volatile memories known in the art.

Storage components 248, in some examples, also include one or more computer-readable storage media. Storage components 248 in some examples include one or more non-transitory computer-readable storage mediums. Storage components 248 may be configured to store larger amounts of information than typically stored by volatile memory. Storage components 248 may further be configured for long-term storage of information as non-volatile memory space and retain information after power on/off cycles. Examples of non-volatile memories include magnetic hard discs, optical discs, floppy discs, flash memories, or forms of electrically programmable memories (EPROM) or electrically erasable and programmable (EEPROM) memories. Storage components 248 may store program instructions and/or information (e.g., data) associated with modules 220, 222, 224, 226, and 228, as well as data stores 234. Storage components 248 may include a memory configured to store data or other information associated with modules 220, 222, 224, 226, and 228, as well as data stores 234.

UI module 220 is analogous to and may include all functionality of UI module 120 of computing device 110 of FIG. 1. In addition, UI module 220 includes text-entry module 226 which performs operations for managing a specific type of user interface that computing device 200 provides at presence-sensitive display 212 for handling textual input from a user. UI module 220 and text-entry module 226 may send information over communication channels 250 that cause display component 202 of presence-sensitive display 212 to present a graphical keyboard from which a user can provide text input (e.g., a sequence of textual characters) by providing tap and non-tap gestures at presence-sensitive input component 204.

Keyboard module 222 may include all functionality of keyboard module 122 of computing device 110 of FIG. 1 and may perform similar operations for text-entry. Keyboard module 122 may be a stand-alone application, service (e.g., accessible from a cloud-based remote computing system or server), or module executing at computing device 110 and in other examples, keyboard module 122 may be a sub-component thereof.

Threshold data stores 234B may include one or more distance or spatial based thresholds, probability thresholds, or other values of comparison that keyboard module 222 uses to infer whether a selection of a key selects a first character by itself or a combination including the first character and a predicted second character. The thresholds stored at threshold data stores 234B may be variable thresholds (e.g., based on a function or lookup table) or fixed values (e.g., pre-programmed during production or via an operating platform update). For example, threshold data store 234B may include a first amount of pressure or pressure range and a second amount of pressure or pressure range. Keyboard module 222 may compare a received amount of pressure to each of the first and second thresholds. If the amount of pressure applied satisfies the first threshold (e.g., is within the first pressure range), keyboard module 222 may increase a probability or score of a character sequence that includes only the letter associated with a key. If the amount of pressure applied satisfies the second threshold (e.g., is within the second pressure range), keyboard module 222 may increase the probability or score of the character sequence that includes a combination of the letter associated with a key and a predicted next letter by a second amount that exceeds the first amount. If the amount of pressure applied satisfies neither the first nor the second thresholds (e.g., is outside of the first and second ranges), keyboard module 222 may decrease the probability or score of the character sequence that includes the letter associated with the key.

In another example, threshold data stores 234B may include a score threshold. Keyboard module 222 may compare a score associated with a candidate word that is determined using modules 224 and/or modules 228 to the score threshold. If the score satisfies (e.g., indicates a score that is more likely than the score threshold), keyboard module 222 may output a character (e.g., a next letter) associated with the candidate word.

In another example, threshold data stores 234B may include a gesture input timing threshold. Keyboard module 222 may compare a time delay between tap gestures to the gesture input timing threshold. If the time delay between tap gestures satisfies (e.g., is less than), keyboard module 222 may determine that the tap gestures are a single user input. If, however, the time delay between tap gestures does not satisfy (e.g., is greater than), keyboard module 222 may determine that the tap gestures different user inputs.

SM module 228 may receive a sequence of touch events as input, and output a character or sequence of characters that likely represents the sequence of touch events, along with a degree of certainty or spatial model score indicative of how likely or with what accuracy the sequence of characters define the touch events. In other words, SM module 228 may perform recognition techniques to infer touch events and/or infer touch events as selections or gestures at keys of a graphical keyboard. Keyboard module 222 may use the spatial model score that is output from SM module 228 in determining a total score for a potential word or words that module 222 outputs in response to text input.

LM module 224 may receive a sequence of characters as input, and output one or more candidate words or word pairs as character sequences that LM module 224 identifies from lexicon data stores 234A as being potential suggestions for the sequence of characters in a language context (e.g., a sentence in a written language). For example, LM module 224 may assign a language model probability to one or more candidate words or pairs of words located at lexicon data store 234A that include at least some of the same characters as the inputted sequence of characters. The language model probability assigned to each of the one or more candidate words or word pairs indicates a degree of certainty or a degree of likelihood that the candidate word or word pair is typically found positioned subsequent to, prior to, and/or within, a sequence of words (e.g., a sentence) generated from text input detected by presence-sensitive input component 204 prior to and/or subsequent to receiving the current sequence of characters being analyzed by LM module 224.

Lexicon data stores 234A may include one or more databases (e.g., hash tables, linked lists, sorted arrays, graphs, etc.) that represent dictionaries for one or more written languages. Each dictionary may include a list of words and word combinations within a written language vocabulary (e.g., including grammars, slang, and colloquial word use). LM module 224 of keyboard module 222 may perform a lookup in lexicon data stores 234A for a sequence of characters by comparing the portions of the sequence to each of the words in lexicon data stores 234A. LM module 224 may assign a similarity coefficient (e.g., a Jaccard similarity coefficient) to each word in lexicon data stores 234A based on the comparison between the inputted sequence of characters and each word in lexicon data stores 234A, and determine one or more candidate words from lexicon data store 234A with a greatest similarity coefficient. In other words, the one or more candidate words with the greatest similarity coefficient may at first represent the potential words in lexicon data stores 234A that have spellings that most closely correlate to the spelling of the sequence of characters. LM module 224 may determine one or more candidate words that include parts or all of the characters of the sequence of characters and determine that the one or more candidate words with the highest similarity coefficients represent potential corrected spellings of the sequence of characters. In some examples, the candidate word with the highest similarity coefficient matches a sequence of characters generated from a sequence of touch events. For example, the candidate words for the sequence of characters h-i-t-h-e-r-e may include “hi”, “hit”, “here”, “hi there”, and “hit here”.

LM module 224 may be an n-gram language model. An n-gram language model may provide a probability distribution for an item xi (letter or word) in a contiguous sequence of items based on the previous items in the sequence (i.e., P(xi|xi−(n−1), . . . , xi−1)) or a probability distribution for the item xi in a contiguous sequence of items based on the subsequent items in the sequence (i.e., P(xi|xi+1, . . . , xi+(n−1))). Similarly, an n-gram language model may provide a probability distribution for an item xi in a contiguous sequence of items based on the previous items in the sequence and the subsequent items in the sequence (i.e., P(xi|xi−(n−1), . . . , xi+(n−1))). For instance, a bigram language model (an n-gram model where n=2), may provide a first probability that the word “there” follows the word “hi” in a sequence (i.e., a sentence) and a different probability that the word “here” follows the word “hit” in a different sentence. A trigram language model (an n-gram model where n=3) may provide a probability that the word “here” succeeds the two words “hey over” in a sequence.

In response to receiving a sequence of characters, LM module 224 may output the one or more words and word pairs from lexicon data stores 234A that have the highest similarity coefficients to the sequence and the highest language model scores. Keyboard module 222 may perform further operations to determine which of the highest ranking words or word pairs to output to text-entry module 226 as a character sequence that best represents a sequence of touch events received from text-entry module 226. Keyboard module 222 may combine the language model scores output from LM module 224 with the spatial model score output from SM module 228 to derive a total score indicating that the sequence of touch events defined by text input represents each of the highest ranking words or word pairs in lexicon data stores 234A.

To provide suggestions of keyboard module 222 that are more useful and relevant and to reduce the amount of time a user searches for a key or suggestion to select, modules 224 and 228 may determine a predicted letter of one or more candidate words that keyboard module 222 causes to be displayed within a graphical key displayed by keyboard module 222. Language module 224 may receive, as input, a character of a key displayed by keyboard module 222, and output a candidate word. The candidate word may represent a character sequence that LM module 224 identifies from lexicon data stores 234A as being a potential suggestion for the inputted character of the key in a language context (e.g., a sentence in a written language). Based on keyboard module 222 determining that a score, determined by modules 224 and 228 and associated with a candidate word, satisfies a score threshold stored by threshold data stores 234B, keyboard module 222 may display, within the key displayed by keyboard module 222, a letter that immediately follows the character of the key in the spelling of the candidate word or words that are determined by LM module 224.

Keyboard module 222 may determine, based on a user input selecting the key displayed by keyboard module 222, whether to output just the character of the key displayed by keyboard module 222, or whether to output the character of the key in addition to the letter that immediately follows the character of the key in the spelling of the candidate word. For example, keyboard module 222 may determine whether to output both the character of the key displayed by keyboard module 222 and the letter that immediately follows the character of the key in the spelling of the candidate word, based on a comparison between an amount of pressure, detected by PSD 212, applied during the user input and one or more pressure thresholds that are stored by threshold data stores 234B. In another example, keyboard module 222 may determine whether to output both the character of the key displayed by keyboard module 222 and the letter that immediately follows the character of the key in the spelling of the candidate word, based on a swipe gesture, detected by PSD 212, during the user input. Any other combination of the language and spatial information may also be used, including machine learned functions for determining whether a user input corresponds to a selection of the first character alone or a selection of a combination of the first character and the second character. In this way, a computing device that operates in accordance with the described techniques may provide suggestions that are more useful and relevant since the example computing device displays two or more characters of a suggested word at a time, rather than the entire word.

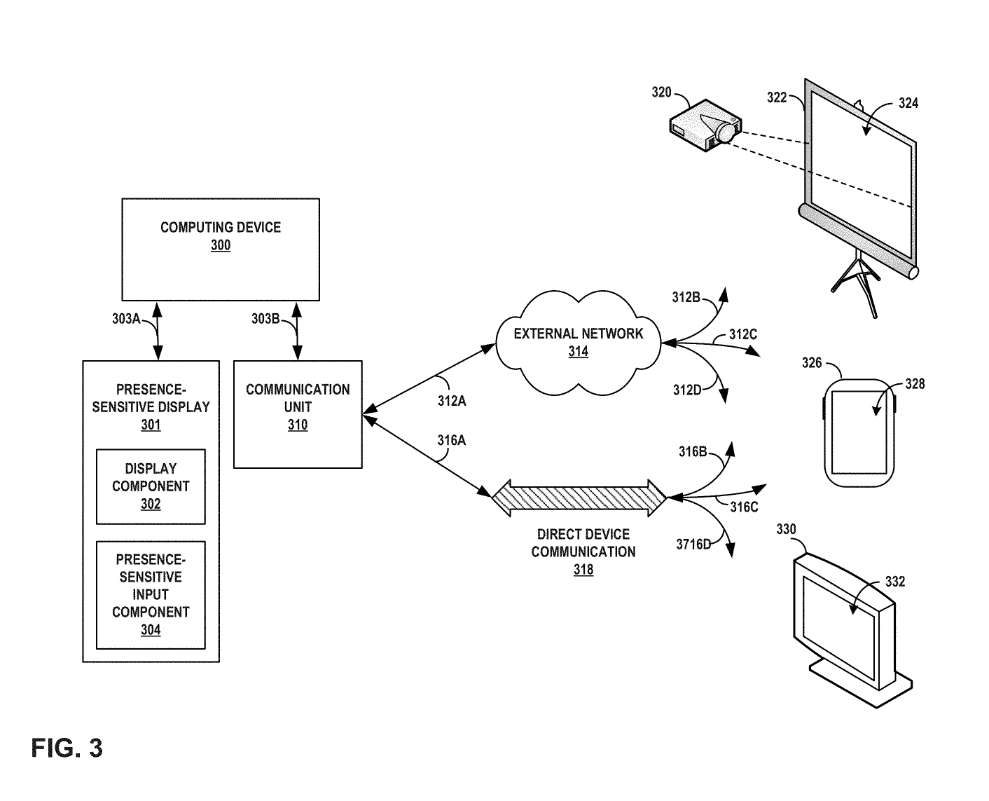

FIG. 3 is a conceptual diagram illustrating an example computing device that outputs graphical content for display at a remote device, in accordance with one or more techniques of the present disclosure. Graphical content, generally, may include any visual information that may be output for display, such as text, images, a group of moving images, etc. The example shown in FIG. 3 includes a computing device 300, presence-sensitive display 301, communication unit 310, projector 320, projector screen 322, tablet device 326, and visual display device 330. Although shown for purposes of examples in FIGS. 1A-C as a stand-alone computing device, a computing device, such as computing device 110, may generally refer to any component or system that includes a processor or other suitable computing environment for executing software instructions and, for example, need not include a presence-sensitive display.

As shown in the example of FIG. 3, computing device 300 may be a processor that includes functionality as described with respect to processors 240 in FIG. 2. In such examples, computing device 300 may be operatively coupled to presence-sensitive display 301 by a communication channel 303A, which may be a system bus or other suitable connection. Computing device 300 may also be operatively coupled to communication unit 310, further described below, by a communication channel 303B, which may also be a system bus or other suitable connection. Although shown separately as an example in FIG. 3, computing device 300 may be operatively coupled to presence-sensitive display 301 and communication unit 310 by any number of one or more communication channels.

In some examples, such as illustrated previously by computing devices in FIGS. 1A-C, computing device 300 may be a portable or mobile device such as mobile phones (including smart phones), laptop computers, etc. In some examples, computing device 300 may be a desktop computers, tablet computers, smart television platforms, cameras, personal digital assistants (PDAs), servers, mainframes, etc.

Presence-sensitive display 301, like PSDs as shown in FIGS. 1A-C, may include display component 302 and presence-sensitive input component 304. Display component 302 may, for example, receive data from computing device 300 and display the graphical content. In some examples, presence-sensitive input component 304 may determine one or more user inputs (e.g., continuous gestures, multi-touch gestures, single-touch gestures, etc.) at presence-sensitive display 301 using capacitive, inductive, and/or optical recognition techniques and send indications of such user input to computing device 300 using communication channel 303A. In some examples, presence-sensitive input component 304 may be physically positioned on top of display component 302 such that, when a user positions an input unit over a graphical element displayed by display component 302, the location at which presence-sensitive input component 304 corresponds to the location of display component 302 at which the graphical element is displayed.

As shown in FIG. 3, computing device 300 may also include and/or be operatively coupled with communication unit 310. Communication unit 310 may include functionality of communication unit 244 as described in FIG. 2. Examples of communication unit 310 may include a network interface card, an Ethernet card, an optical transceiver, a radio frequency transceiver, or any other type of device that can send and receive information. Other examples of such communication units may include Bluetooth, 3G, 4G, LTE, and Wi-Fi radios, Universal Serial Bus (USB) interfaces, etc. Computing device 300 may also include and/or be operatively coupled with one or more other devices, e.g., input devices, output devices, memory, storage devices, etc. that are not shown in FIG. 3 for purposes of brevity and illustration.

FIG. 3 also illustrates a projector 320 and projector screen 322. Other such examples of projection devices may include electronic whiteboards, holographic display devices, and any other suitable devices for displaying graphical content. Projector 320 and projector screen 322 may include one or more communication units that enable the respective devices to communicate with computing device 300. In some examples, the one or more communication units may enable communication between projector 320 and projector screen 322. Projector 320 may receive data from computing device 300 that includes graphical content. Projector 320, in response to receiving the data, may project the graphical content onto projector screen 322. In some examples, projector 320 may determine one or more user inputs (e.g., continuous gestures, multi-touch gestures, single-touch gestures, etc.) at projector screen using optical recognition or other suitable techniques and send indications of such user input using one or more communication units to computing device 300.

Projector screen 322, in some examples, may include a presence-sensitive display 324. Presence-sensitive display 324 may include a subset of functionality or all of the functionality of UI module 120 as described in this disclosure. In some examples, presence-sensitive display 324 may include additional functionality. Projector screen 322 (e.g., an electronic whiteboard), may receive data from computing device 300 and display the graphical content. In some examples, presence-sensitive display 324 may determine one or more user inputs (e.g., continuous gestures, multi-touch gestures, single-touch gestures, etc.) at projector screen 322 using capacitive, inductive, and/or optical recognition techniques and send indications of such user input using one or more communication units to computing device 300.

FIG. 3 also illustrates tablet device 326 and visual display device 330. Tablet device 326 and visual display device 330 may each include computing and connectivity capabilities. Examples of tablet device 326 may include e-reader devices, convertible notebook devices, hybrid slate devices, etc. Examples of visual display device 330 may include televisions, computer monitors, etc. As shown in FIG. 3, tablet device 326 may include a presence-sensitive display 328. Visual display device 330 may include a presence-sensitive display 332. Presence-sensitive displays 328, 332 may include a subset of functionality or all of the functionality of UI device 120 as described in this disclosure. In some examples, presence-sensitive displays 328, 332 may include additional functionality. In any case, presence-sensitive display 332, for example, may receive data from computing device 300 and display the graphical content. In some examples, presence-sensitive display 332 may determine one or more user inputs (e.g., continuous gestures, multi-touch gestures, single-touch gestures, etc.) at projector screen using capacitive, inductive, and/or optical recognition techniques and send indications of such user input using one or more communication units to computing device 300.

As described above, in some examples, computing device 300 may output graphical content for display at presence-sensitive display 301 that is coupled to computing device 300 by a system bus or other suitable communication channel. Computing device 300 may also output graphical content for display at one or more remote devices, such as projector 320, projector screen 322, tablet device 326, and visual display device 330. For instance, computing device 300 may execute one or more instructions to generate and/or modify graphical content in accordance with techniques of the present disclosure. Computing device 300 may output the data that includes the graphical content to a communication unit of computing device 300, such as communication unit 310. Communication unit 310 may send the data to one or more of the remote devices, such as projector 320, projector screen 322, tablet device 326, and/or visual display device 330. In this way, computing device 300 may output the graphical content for display at one or more of the remote devices. In some examples, one or more of the remote devices may output the graphical content at a presence-sensitive display that is included in and/or operatively coupled to the respective remote devices.

In some examples, computing device 300 may not output graphical content at presence-sensitive display 301 that is operatively coupled to computing device 300. In other examples, computing device 300 may output graphical content for display at both a presence-sensitive display 301 that is coupled to computing device 300 by communication channel 303A, and at one or more remote devices. In such examples, the graphical content may be displayed substantially contemporaneously at each respective device. For instance, some delay may be introduced by the communication latency to send the data that includes the graphical content to the remote device. In some examples, graphical content generated by computing device 300 and output for display at presence-sensitive display 301 may be different than graphical content display output for display at one or more remote devices.

Computing device 300 may send and receive data using any suitable communication techniques. For example, computing device 300 may be operatively coupled to external network 314 using network link 312A. Each of the remote devices illustrated in FIG. 3 may be operatively coupled to network external network 314 by one of respective network links 312B, 312C, and 312D. External network 314 may include network hubs, network switches, network routers, etc., that are operatively inter-coupled thereby providing for the exchange of information between computing device 300 and the remote devices illustrated in FIG. 3. In some examples, network links 312A-D may be Ethernet, asynchronous transfer mode, or other network connections. Such connections may be wireless and/or wired connections.

In some examples, computing device 300 may be operatively coupled to one or more of the remote devices included in FIG. 3 using direct device communication 318. Direct device communication 318 may include communications through which computing device 300 sends and receives data directly with a remote device, using wired or wireless communication. That is, in some examples of direct device communication 318, data sent by computing device 300 may not be forwarded by one or more additional devices before being received at the remote device, and vice-versa. Examples of direct device communication 318 may include Bluetooth, Near-Field Communication, Universal Serial Bus, Wi-Fi, infrared, etc. One or more of the remote devices illustrated in FIG. 3 may be operatively coupled with computing device 300 by communication links 316A-D. In some examples, communication links 312A-D may be connections using Bluetooth, Near-Field Communication, Universal Serial Bus, infrared, etc. Such connections may be wireless and/or wired connections.

In accordance with techniques of the disclosure, computing device 300 may be operatively coupled to one or more of PSD 301, projector screen 322, tablet device 326, and PSD 332, computing device 300 using external network 314 to display, within a single key of a graphical keyboard, two or more next letters that the device predicts will be selected from a subsequent input at the graphical keyboard. For instance, rather than a user selecting a suggestion of an entire candidate word outside of the graphical keyboard, then necessarily, wading between a suggestion region and a graphical keyboard region of projector screen 322, computing device 300 may permit the user to select a suggestion, within a single key of a graphical keyboard, of two or more next letters that computing device 300 predicts will be selected from a subsequent input at the graphical keyboard. More specifically, projector screen 322 may display one or more predicted next letters within a single key of a graphical keyboard that is displayed at projector screen 322. In response to presence-sensitive display 324 receiving an input selecting the single key of the graphical keyboard by the user, computing device 300 may determine whether the input selects a character normally associated with the single key alone or a both the character normally associated with the single key and the one or more predicted next letters.

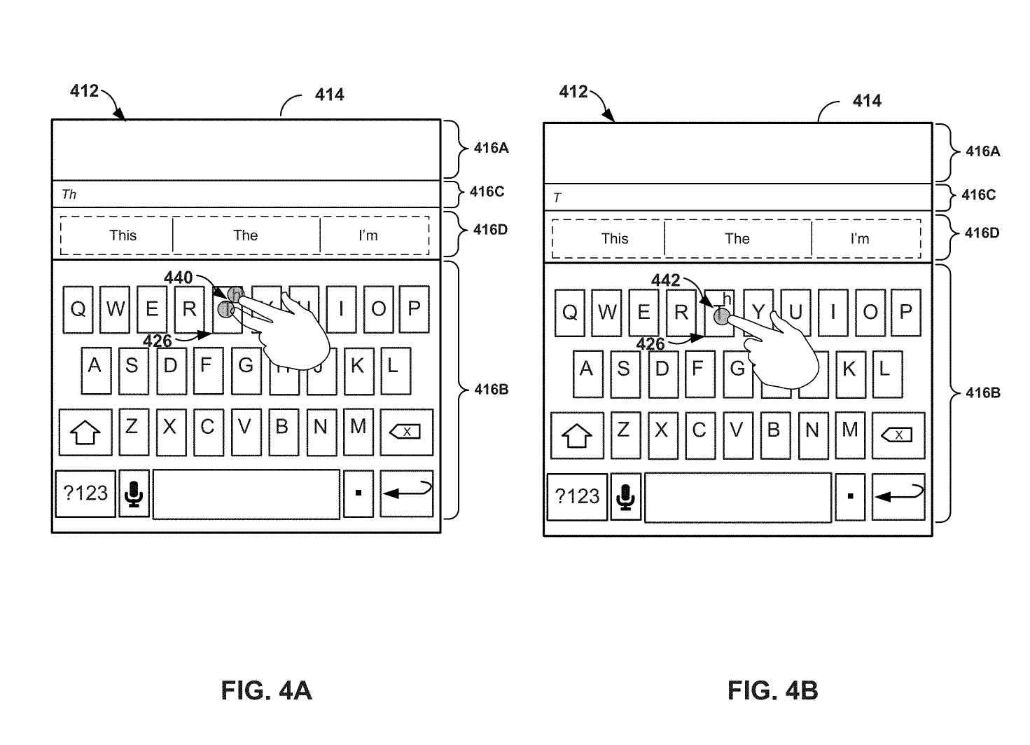

FIGS. 4A-4B are conceptual diagrams illustrating further details of a first example of computing device 110 shown in FIG. 1A, in accordance with one or more techniques of the present disclosure. As shown, PSD 412 may be an example of PSD 112 of FIG. 1A. For example, PSD 412 may be included in computing device 110 of FIG. 1A and PSD 412 may be used with UI module 120 and keyboard module 122 as shown in FIG. 1A. As shown, PSD 412 may display user interface 414, which may be substantially similar to user interface 114 of FIG. 1A. For instance, user interface 414 may include output region 416A that is an example of output region 116A of FIG. 1A, graphical keyboard 416B that is an example of graphical keyboard 116B of FIG. 1A, edit region 416C that is an example of edit region 116C of FIG. 1A, and suggestion region 416D that is an example of suggestion region 116D of FIG. 1.

In the example of FIG. 4A, PSD 412 receives an indication of user input 440 selecting key 426 of graphical keyboard 416B. As shown in FIG. 4A, user input 440 includes: a first tap gesture at a location of PSD 412 that is within key 426 and substantially over a graphical indication of a first character (e.g., ‘T’), and a second tap gesture at a location of PSD 412 that is within key 426 and substantially over a graphical indication of a second character (e.g., ‘h’). More specifically, PSD 412 may receive an indication of user input 440 as a user places a first finger substantially over the graphical indication of the first character (e.g., ‘T’) and a second finger substantially over the graphical indication of the second character (e.g., ‘h’).

Although FIG. 4A shows the placement of the first finger within key 426 as simultaneous with the placement of the second finger within key 426, some examples permit PSD 412 to receive an indication of user input as a user provides multiple tap gestures that are not simultaneous. For instance, PSD 412 and/or computing device 110 may use a gesture input timing threshold. More specifically, keyboard module 122 of computing device 110 may determine that a first gesture and a second gesture form a single user input when a time difference or delay between the first gesture and the second gesture satisfies (e.g., is less than) the gesture input timing threshold.

In response to receiving an indication of user input 440, keyboard module 122 may determine whether user input 440 corresponds to a selection of the first character alone or a selection of a combination of the first character and the second character. For example, keyboard module 122 may determine whether user input 440 corresponds to the first character alone (e.g., the letter ‘t’) or a combination including the first character and the second character (e.g., the phrase ‘th’) based on a quantity of taps (e.g., different touch down and touch up events) associated with user input 440. More specifically, in response to keyboard module 122 receiving, from PSD 412, information indicating that user input 440 includes the placement of a first finger within key 426 as substantially simultaneous (e.g., within a gesture input timing threshold) with the placement of a second finger within key 426, keyboard module 122 may determine that user input 440 corresponds to the combination including the first character and the second character (e.g., the phrase ‘th’).

In the example of FIG. 4A, in response to determining that user input 440 corresponds to a selection of a combination of the first character and the second character, keyboard module 122 may cause UI module 120 to output, for display on PSD 412, the combination including the first character and the second character (e.g., the phrase ‘th’) to PSD 412. As shown in FIG. 4A, in response, PSD 412 displays the combination including the first character and the second character as text in edit region 416C.

In the example of FIG. 4B, however, PSD 412 receives an indication of user input 442 selecting key 426 of graphical keyboard 416B. As shown in FIG. 4B, user input 442 includes a first tap gesture alone within key 426. More specifically, a user may place only a first finger within key 426 without providing any other gestures with any additional fingers.

In response to receiving an indication of user input 442, keyboard module 122 may determine whether user input 442 corresponds to a selection of the first character alone or a selection of a combination of the first character and the second character. For example, keyboard module 122 may determine whether user input 442 corresponds to the first character alone (e.g., the letter ‘t’) or a combination including the first character and the second character (e.g., the phrase ‘th’) based on a quantity of taps associated with user input 442. More specifically, in response to keyboard module 122 receiving, from PSD 412, information indicating that user input 442 includes the placement of a first finger alone within key 426, keyboard module 122 may determine that user input 442 corresponds to the first character alone (e.g., the letter ‘t’).

In the example of FIG. 4B, in response to determining user input 442 corresponds to a selection of the first character alone (e.g., the letter ‘t’), keyboard module 122 may cause UI module 120 to output, for display on PSD 412, the first character alone to PSD 412. As shown in FIG. 4B, in response, PSD 412 displays the first character alone as text in edit region 416C.

Although FIGS. 4A-4B illustrate a user input having two gestures, any suitable number of gestures may be used. For instance, a user input that includes three taps may indicate a selection of a predicted letter and a user input that includes one or two taps may indicate a selection of a character normally associated with a key, a user input that includes four taps may indicate a selection of a predicted letter and a user input that includes one, two, or three taps may indicate a selection of a character normally associated with a key, and so on. Additionally, although FIGS. 4A-4B illustrate the placement of the middle finger and the index finger of the left hand within key 426, some examples permit a user to use other combinations of fingers and/or a stylus pen. For instance, a user may apply a tapping gesture using a stylus pen by contacting the stylus pen with PSD 512 instead of using a right index finger of a user's left hand. In another instance, a user may apply a tapping gesture using an index finger of a user's right hand instead of using an index finger of a user's left hand.

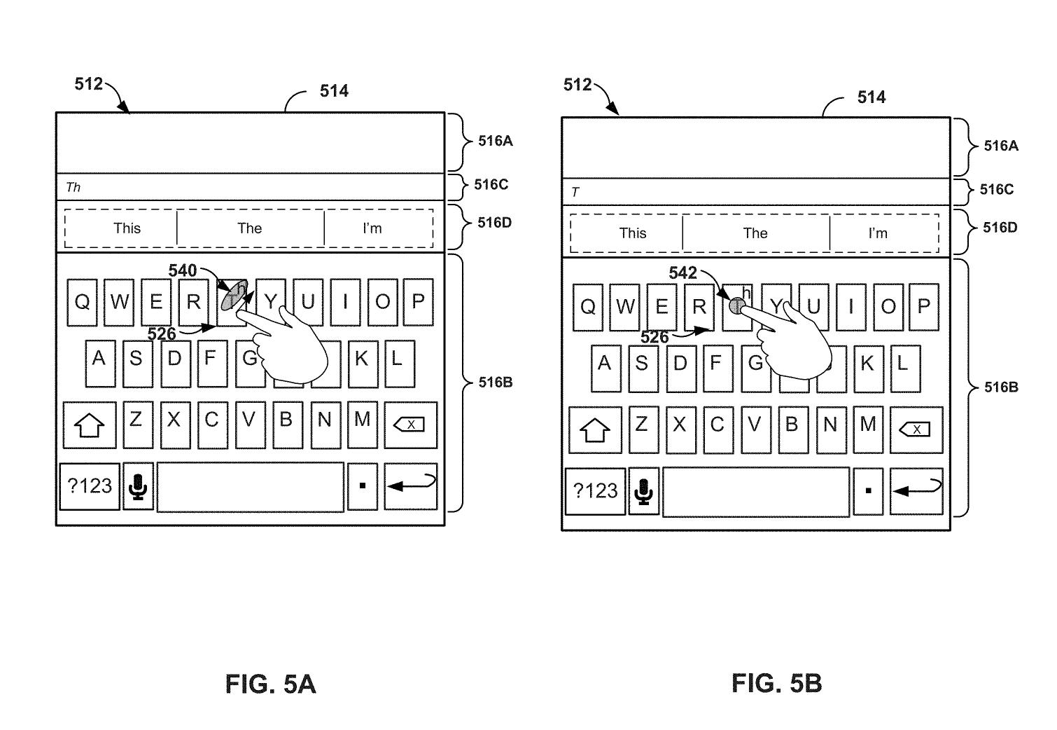

FIGS. 5A-5B are conceptual diagrams illustrating further details of a second example of computing device 110 shown in FIG. 1A, in accordance with one or more techniques of the present disclosure. As shown, PSD 512 may be an example of PSD 112 of FIG. 1A. For example, PSD 512 may be included in computing device 110 of FIG. 1A and PSD 512 may be used with UI module 120 and keyboard module 122 as shown in FIG. 1A. As shown, PSD 512 may display user interface 514, which may be substantially similar to user interface 114 of FIG. 1A. For instance, user interface 514 may include output region 516A that is an example of output region 116A of FIG. 1A, graphical keyboard 516B that is an example of graphical keyboard 116B of FIG. 1A, edit region 516C that is an example of edit region 116C of FIG. 1A, and suggestion region 516D that is an example of suggestion region 116D of FIG. 1.

In the example of FIG. 5A, PSD 512 receives an indication of user input 540 selecting key 526 of graphical keyboard 516B. As shown in FIG. 5A, user input 540 includes a swipe gesture within key 526 that moves from a graphical indication of a first character (e.g., ‘T’) within key 526 and towards a graphical indication of a second character (e.g. ‘h’) within key 526. More specifically, a user may place a finger substantially over the graphical indication of the first character (e.g., ‘T’) and may slide, while maintaining contact with PSD 512, the finger towards the graphical indication of a second character (e.g. ‘h’) within key 526.

In response to receiving an indication of user input 540, keyboard module 122 may determine whether user input 540 corresponds to a selection of the first character alone or a selection of a combination of the first character and the second character. For example, keyboard module 122 may determine whether user input 540 corresponds to the first character alone (e.g., the letter ‘t’) or a combination including the first character and the second character (e.g., the phrase ‘th’) based on a swipe direction associated with user input 540. More specifically, in response to keyboard module 122 receiving, from PSD 512, information indicating that user input 540 includes a swipe gesture within key 526 that moves from a graphical indication of a first character (e.g., ‘T’) within key 526 and towards a graphical indication of a second character (e.g. ‘h’) within key 526, keyboard module 122 may determine that user input 540 corresponds to the combination including the first character and the second character (e.g., the phrase ‘th’).

In the example of FIG. 5A, in response to determining that user input 540 corresponds to a selection of a combination of the first character and the second character, keyboard module 122 may cause UI module 120 to output, for display on PSD 512, the combination including the first character and the second character (e.g., the phrase ‘th’) to PSD 512. As shown in FIG. 5A, in response, PSD 512 displays the combination including the first character and the second character as text in edit region 516C.

In the example of FIG. 5B, however, PSD 512 receives an indication of user input 542 selecting key 526 of graphical keyboard 516B. As shown in FIG. 5B, user input 542 includes a tap gesture within key 526 without a swipe gesture. More specifically, a user may place a finger within key 526 and move, without applying a swipe gesture, the finger away from PSD 516.

In response to receiving an indication of user input 542, keyboard module 122 may determine whether user input 542 corresponds to a selection of the first character alone or a selection of a combination of the first character and the second character. For example, keyboard module 122 may determine whether user input 542 corresponds to the first character alone (e.g., the letter ‘t’) or a combination including the first character and the second character (e.g., the phrase ‘th’) based on a swipe direction associated with user input 540. More specifically, in response to keyboard module 122 receiving, from PSD 512, an indication that user input 542 includes a tap gesture within key 526 without a swipe gesture, keyboard module 122 may determine that user input 542 corresponds to the first character alone (e.g., the letter ‘t’). In another example, in response to keyboard module 122 receiving, from PSD 512, an indication that user input 542 includes a tap gesture within key 526 with a swipe gesture that moves from a graphical indication of a first character (e.g., ‘T’) within key 526 and away from a graphical indication of a second character (e.g. ‘h’) within key 526, keyboard module 122 may determine that user input 542 corresponds to the first character alone (e.g., the letter ‘t’).

In the example of FIG. 5B, in response to determining user input 542 corresponds to a selection of the first character alone (e.g., the letter ‘t’), keyboard module 122 may cause UI module 120 to output, for display on PSD 512, the first character alone to PSD 512. As shown in FIG. 5B, in response, PSD 512 displays the first character alone as text in edit region 516C.

Although FIGS. 5A-5B illustrate the placement of the index finger of the left hand within key 526, some examples permit a user to use other combinations of fingers and/or a stylus pen. For instance, a user may apply a swiping gesture using a stylus pen by contacting the stylus pen with PSD 512 instead of using an index finger of a user's left hand. In another instance, a user may apply a swiping gesture using an index finger of a user's right hand instead of using an index finger of a user's left hand.

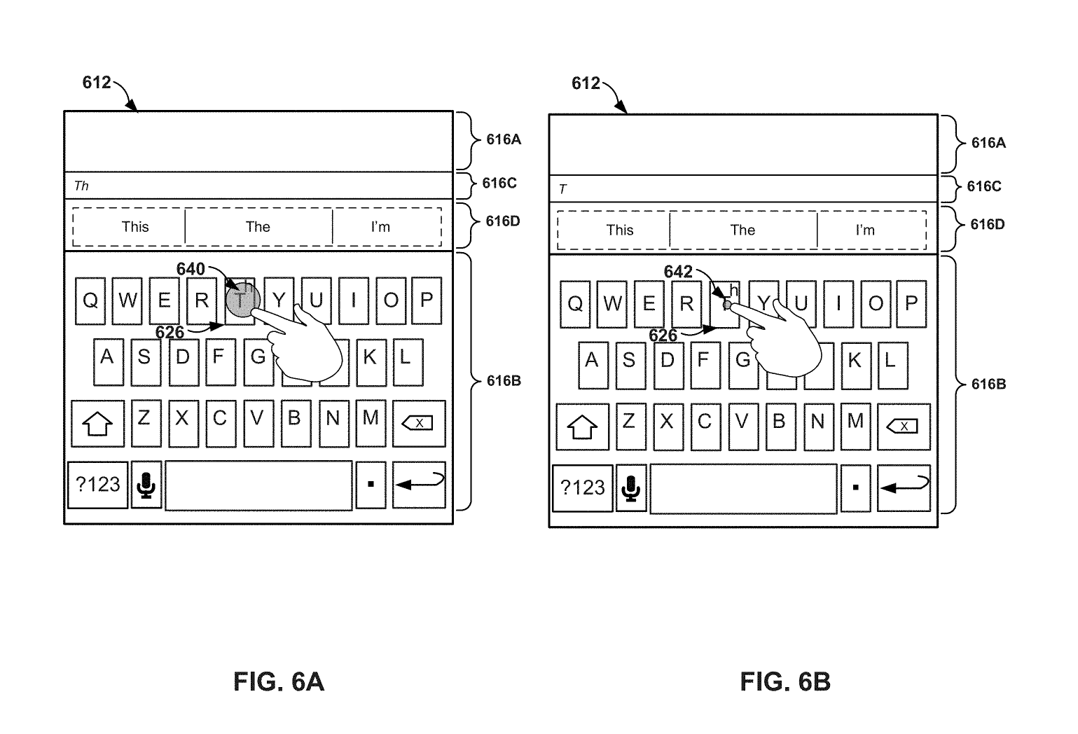

FIGS. 6A-6B are conceptual diagrams illustrating further details of a third example of computing device 110 shown in FIG. 1A, in accordance with one or more techniques of the present disclosure. As shown, PSD 612 may be an example of PSD 112 of FIG. 1A. For example, PSD 612 may be included in computing device 110 of FIG. 1A and PSD 612 may be used with UI module 120 and keyboard module 122 as shown in FIG. 1A. As shown, PSD 612 may display user interface 614, which may be substantially similar to user interface 114 of FIG. 1A. For instance, user interface 614 may include output region 616A that is an example of output region 116A of FIG. 1A, graphical keyboard 616B that is an example of graphical keyboard 116B of FIG. 1A, edit region 616C that is an example of edit region 116C of FIG. 1A, and suggestion region 616D that is an example of suggestion region 116D of FIG. 1.

In the example of FIG. 6A, PSD 612 receives an indication of user input 640 selecting key 626 of graphical keyboard 616B. As shown in FIG. 6A, user input 640 includes a tap gesture applied with a first amount of pressure within key 626. More specifically, a user may place a finger substantially over the graphical indication of the first character (e.g., ‘T’) and in doing so, apply the first amount of pressure to the PSD 612, at key 626.

In response to receiving an indication of user input 640, keyboard module 122 may determine whether user input 640 corresponds to a selection of the first character alone or a selection of a combination of the first character and the second character. For example, keyboard module 122 may determine whether user input 640 corresponds to the first character alone (e.g., the letter ‘t’) or a combination including the first character and the second character (e.g., the phrase ‘th’) based on an amount of pressure associated with user input 640. More specifically, in response to keyboard module 122 receiving, from PSD 612, an indication that user input 640 that includes the first amount of pressure that satisfies (e.g., exceeds, within a range, or the like) a pressure threshold, keyboard module 122 may determine that user input 640 corresponds to the combination including the first character and the second character (e.g., the phrase ‘th’). The pressure threshold may be a pressure value or a range of pressure values. In some examples, the pressure threshold may be automatically determined by computing device 110. In some examples, the pressure threshold may be user selected.

In the example of FIG. 6A, in response to determining that user input 640 corresponds to a selection of a combination of the first character and the second character, keyboard module 122 may cause UI module 120 to output, for display on PSD 612, the combination including the first character and the second character (e.g., the phrase ‘th’) to PSD 612. As shown in FIG. 6A, in response, PSD 612 displays the combination including the first character and the second character as text in edit region 616C.

In the example of FIG. 6B, however, PSD 612 receives an indication of user input 642 selecting key 626 of graphical keyboard 616B. As shown in FIG. 6B, user input 642 includes a tap gesture applied with a second amount of pressure within key 626. More specifically, a user may place a finger substantially over the graphical indication of the first character (e.g., ‘T’) and apply the second pressure, to the PSD 612, at key 626

In response to receiving an indication of user input 642, keyboard module 122 may determine whether user input 642 corresponds to a selection of the first character alone or a selection of a combination of the first character and the second character. For example, keyboard module 122 may determine whether user input 642 corresponds to the first character alone (e.g., the letter ‘t’) or a combination including the first character and the second character (e.g., the phrase ‘th’) based on an amount of pressure associated with user input 642. More specifically, in response to keyboard module 122 receiving, from PSD 612, an indication that user input 640 includes the second amount of pressure that does not satisfy (e.g., does not exceed, outside a range, or the like) the pressure threshold, keyboard module 122 may determine that user input 642 corresponds to the first character alone (e.g., the letter ‘t’).

In the example of FIG. 6B, in response to determining user input 642 corresponds to a selection of the first character alone (e.g., the letter ‘t’), keyboard module 122 may cause UI module 120 to output, for display on PSD 612, the first character alone to PSD 612. As shown in FIG. 6B, in response, PSD 612 displays the first character alone as text in edit region 616C.

Although FIGS. 6A-6B illustrate the placement of the index finger of the left hand within key 626, some examples permit a user to use other combinations of fingers and/or a stylus pen. For instance, a user may apply an amount of pressure using a stylus pen by contacting the stylus pen with PSD 612 instead of using an index finger of a user's left hand. In another instance, a user may apply an amount of pressure using an index finger of a user's right hand instead of using an index finger of a user's left hand. Additionally, although FIGS. 6A-6B illustrate a higher pressure (e.g., first amount of pressure) satisfying a pressure threshold and a lower pressure (e.g., second amount of pressure) not satisfying the pressure threshold, in other examples, a lower pressure may satisfy a pressure threshold and a higher pressure may not satisfy the pressure threshold.

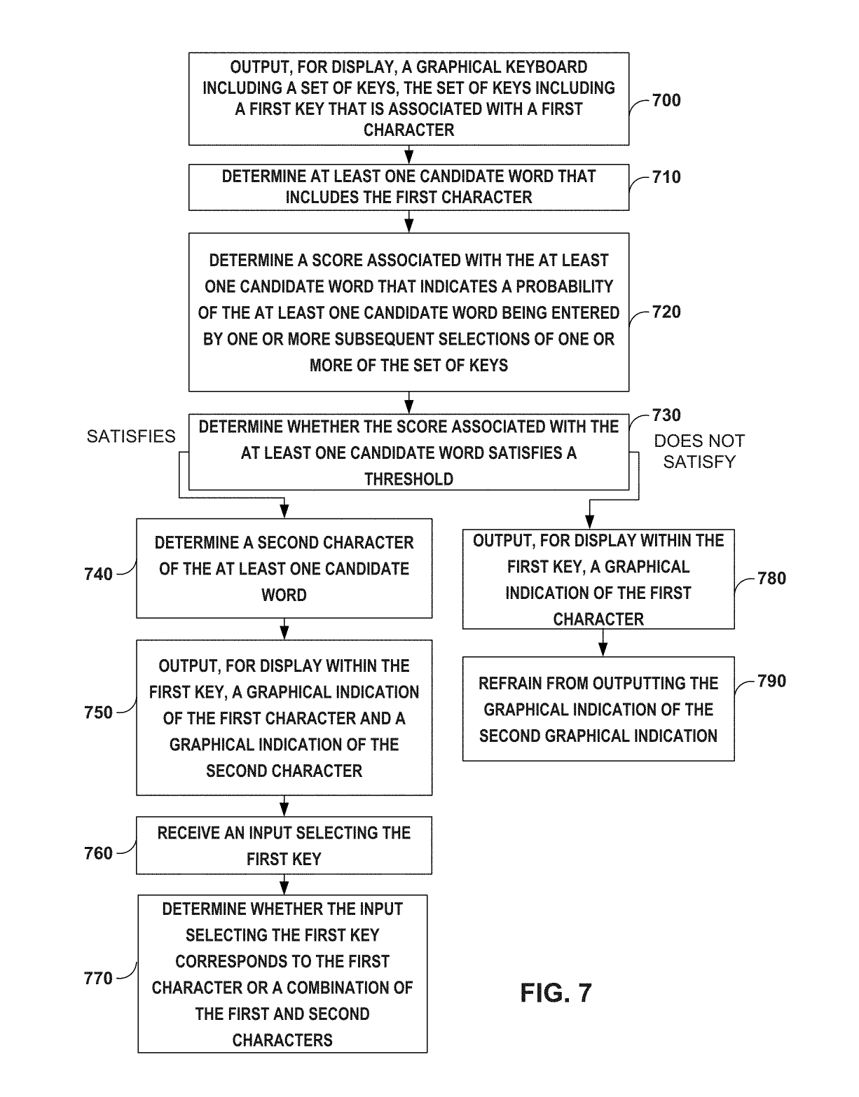

FIG. 7 is a flow diagram illustrating example operations of an example computing device configured to predict next letters and display them within keys of a graphical keyboard, in accordance with one or more techniques of the present disclosure. The process of FIG. 7 may be performed by one or more processors of a computing device, such as computing device 110 of FIG. 1A. The acts of the process of FIG. 7 may in some examples, be repeated, omitted, and/or performed in any order. For purposes of illustration only, FIG. 7 is described below within the context of computing device 110 of FIG. 1A and computing device 210 of FIG. 2.

In the example of FIG. 7, computing device 110 outputs (700), for display, a graphical keyboard including a set of keys, the set of keys including a first key that is associated with a first character. For example, PSD 112 of FIG. 1A may display graphical keyboard 116B with keys 118. In the example, PSD 112 may display key 126 that is associated with the character ‘T’.

Computing device 110 determines (710) at least one candidate word that includes the first character. For example, keyboard module 122 of computing device 110 may output the character ‘T’ to a language mode module, for instance, LM module 224 of FIG. 2, and receive a candidate word (e.g., “That”) that includes the character ‘T’. Computing device 110 determines (720) a score associated with the at least one candidate word that indicates a probability of the at least one candidate word being entered by one or more subsequent selections of one or more of the set of keys. For example, in response to keyboard module 122 of computing device 110 outputting the character ‘T’ to the language mode module, computing device 110 may receive, from the language mode module the score associated with the at least one candidate word. Computing device 730 determines (730) whether the score associated with the at least one candidate word satisfies a threshold. For example, computing device 110 may determine whether the score associated with the at least one candidate word indicates a higher probability that the at least one candidate word will be selected than a probability indicated by the threshold.

In response to computing device 110 determining that the score associated with the at least one candidate word satisfies the threshold (“SATISFIES” of 730), computing device 110 determines (740) a second character of the at least one candidate word. For example, computing device 110 may determine that the character immediately following the first character in the spelling of the at least one candidate word is the second character. Computing device outputs (750), for display within the first key, a graphical indication of the first character and a graphical indication of the second character. For example, PSD 112 displays, within key 126, a graphical indication of the first character (e.g., ‘T’) and a graphical indication of the second character (e.g., ‘h’).

Computing device 110 receives (760) an input selecting the first key. For example, PSD 112 receives user input 140 of FIG. 1B. In another example, PSD 112 receives user input 142 of FIG. 1C. Computing device 110 determines (770) whether the input selecting the first key corresponds to the first character or a combination of the first and second characters. For example, in response to PSD 112 receiving user input 140 of FIG. 1B, computing device 110 determines that user input 140 selects the combination of the first and second characters. More specifically, keyboard module 122 of computing device 110 may determine that user input 140 selects the combination of the first and second characters based on a quantity of taps associated with user input 140, a swipe direction associated with user input 140, an amount of pressure associated with user input 140, or another characteristic or parameter associated with a selection of key 126.

In another example, in response to PSD 112 receiving user input 142 of FIG. 1C, computing device 110 determines that user input 142 selects the first character alone. More specifically, keyboard module 122 of computing device 110 may determine that user input 142 selects the first character alone based on a quantity of taps associated with user input 142, a swipe direction associated with user input 142, an amount of pressure associated with user input 142, or another characteristic or parameter associated with a selection of key 126.

In response to computing device 110 determining that the score associated with the at least one candidate word does not satisfy the threshold (“DOES NOT SATISFY” of 730), computing device 110 outputs (780), for display within the first key, a graphical indication of the first character. For example, computing device 110 outputs, for display on PSD 112, within key 126, a graphical indication of the first character (e.g., ‘T’) alone. Computing device 110 refrains (790) from outputting the graphical indication of the second graphical indication. For example, computing device 110 outputs, for display on PSD 112, within key 126, a graphical indication of the first character (e.g., ‘T’) without the graphical indication of the second character (e.g., ‘h’).

The following numbered clauses may illustrate one or more aspects of the disclosure:

Clause 1. A method comprising: outputting, by a computing device, for display, a graphical keyboard comprising a plurality of keys, the plurality of keys including a first key that is associated with a first character; determining, by the computing device, at least one candidate word that includes the first character; determining, by the computing device, a score associated with the at least one candidate word that indicates a probability of the at least one candidate word being entered by one or more subsequent selections of one or more of the plurality of keys; and responsive to determining that the score associated with the at least one candidate word satisfies a threshold: determining, by the computing device, based on a spelling of the at least one candidate word, a second character of the at least one candidate word, wherein the second character immediately follows the first character in the spelling of the at least one candidate word; and outputting, by the computing device, for display within the first key, a graphical indication of the first character and a graphical indication of the second character.

Clause 2. The method of clause 1, further comprising: after outputting the graphical indication of the first character and the graphical indication of the second character, receiving, by the computing device, an input selecting the first key; and determining, by the computing device, whether the input selecting the first key corresponds to the first character alone or to the first character followed by the second character.

Clause 3. The method of any combination of clauses 1-2, further comprising: determining, by the computing device, whether the input selecting the first key is a single tap gesture within the first key or a combination comprising a first tap gesture within the first key and a second tap gesture within the first key; and responsive to determining that the input selecting the first key is the combination comprising the first tap gesture within the first key and the second tap gesture within the first key, outputting, by the computing device, for display, the first character and the second character.

Clause 4. The method of any combination of clauses 1-3, further comprising: responsive to determining that the input selecting the first key is the single tap gesture within the first key, outputting, by the computing device, for display, the first character.

Clause 5. The method of any combination of clauses 1-4, further comprising: determining, by the computing device, whether the input selecting the first key is a swipe gesture within the first key that moves towards the graphical indication of the second character; and responsive to determining that the input selecting the first key is the swipe gesture within the first key that moves towards the graphical indication of the second character, outputting, by the computing device, for display, the first character and the second character.

Clause 6. The method of any combination of clauses 1-5, further comprising: responsive to determining that the input selecting the first key is not the swipe gesture within the first key that moves towards the graphical indication of the second character, outputting, by the computing device, for display, the first character.

Clause 7. The method of any combination of clauses 1-6, further comprising: determining, by the computing device, whether the input selecting the first key satisfies a pressure threshold; and responsive to determining that the input selecting the first key satisfies the pressure threshold, outputting, by the computing device, for display, the first character and the second character.

Clause 8. The method of any combination of clauses 1-7, further comprising: responsive to determining that the input selecting the first key does not satisfy the pressure threshold, outputting, by the computing device, for display, the first character.

Clause 9. The method of any combination of clauses 1-8, further comprising: responsive to determining that the score associated with the at least one candidate word does not satisfy the threshold: outputting, by the computing device, for display within the first key, the graphical indication of the first character; and refraining from outputting, by the computing device, the graphical indication of the second graphical indication.

Clause 10. A computing device comprising: a presence-sensitive display; at least one processor; and a memory that stores instructions that, when executed by the at least one processor, cause the at least one processor to: output, for display at the presence-sensitive display, a graphical keyboard comprising a plurality of keys, the plurality of keys including a first key that is associated with a first character; determine at least one candidate word that includes the first character; determine a score associated with the at least one candidate word that indicates a probability of the at least one candidate word being entered by one or more subsequent selections of one or more of the plurality of keys; and responsive to determining that the score associated with the at least one candidate word satisfies a threshold: determine, based on a spelling of the at least one candidate word, a second character of the at least one candidate word, wherein the second character immediately follows the first character in the spelling of the at least one candidate word; and output, for display within the first key, a graphical indication of the first character and a graphical indication of the second character.

Clause 11. The computing device of clause 10, wherein the instructions, when executed, cause the at least one processor to: after outputting the graphical indication of the first character and the graphical indication of the second character, receive an input selecting the first key; and determine whether the input selecting the first key corresponds to the first character alone or to the first character followed by the second character.

Clause 12. The computing device of any combination of clauses 10-11, wherein the instructions, when executed, cause the at least one processor to: determine whether the input selecting the first key is a single tap gesture within the first key or a combination comprising a first tap gesture within the first key and a second tap gesture within the first key; and responsive to determining that the input selecting the first key is the combination comprising the first tap gesture within the first key and the second tap gesture within the first key, output, for display the presence-sensitive display, the first character and the second character.

Clause 13. The computing device of any combination of clauses 10-12, wherein the instructions, when executed, cause the at least one processor to: responsive to determining that the input selecting the single key is the first tap gesture within the first key, output, for display at the presence-sensitive display, the first character.

Clause 14. The computing device of any combination of clauses 10-13, wherein the instructions, when executed, cause the at least one processor to: determine whether the input selecting the first key is a swipe gesture within the first key that moves towards the graphical indication of the second character; and responsive to determining that the input selecting the first key is the swipe gesture within the first key that moves towards the graphical indication of the second character, output, for display at the presence-sensitive display, the first character and the second character.

Clause 15. The computing device of any combination of clauses 10-14, wherein the instructions, when executed, cause the at least one processor to: responsive to determining that the input selecting the first key is not the swipe gesture within the first key that moves towards the graphical indication of the second character, output, for display at the presence-sensitive display, the first character.

Clause 16. The computing device of any combination of clauses 10-15, wherein the instructions, when executed, cause the at least one processor to: determine whether the input selecting the first key satisfies a pressure threshold; and responsive to determining that the input selecting the first key satisfies the pressure threshold, output, for display at the presence-sensitive display, the first character and the second character.

Clause 17. The computing device of any combination of clauses 10-16, wherein the instructions, when executed, cause the at least one processor to: responsive to determining that the input selecting the first key does not satisfy the pressure threshold, output, for display at the presence-sensitive display, the first character.

Clause 18. The computing device of any combination of clauses 10-17, wherein the instructions, when executed, cause the at least one processor to: responsive to determining that the score associated with the at least one candidate word does not satisfy the threshold: output, for display within the first key, the graphical indication of the first character; and refrain from outputting the graphical indication of the second graphical indication.

Clause 19. A computer-readable storage medium encoded with instructions that, when executed by at least one processor of a computing device, cause the at least one processor to: output, for display, a graphical keyboard comprising a plurality of keys, the plurality of keys including a first key that is associated with a first character; determine at least one candidate word that includes the first character; determine a score associated with the at least one candidate word that indicates a probability of the at least one candidate word being entered by one or more subsequent selections of one or more of the plurality of keys; and responsive to determining that the score associated with the at least one candidate word satisfies a threshold: determine, based on a spelling of the at least one candidate word, a second character of the at least one candidate word, wherein the second character immediately follows the first character in the spelling of the at least one candidate word; and output, for display within the first key, a graphical indication of the first character and a graphical indication of the second character.

Clause 20. The computer-readable storage medium of clause 19, wherein the instructions, when executed, further cause the at least one processor to: after outputting the graphical indication of the first character and the graphical indication of the second character, receive an input selecting the first key; and determine whether the input selecting the first key corresponds to the first character alone or to the first character followed by the second character.

Clause 21. The computer-readable storage medium of any combination of clauses 19-20, wherein the instructions, when executed, further cause the at least one processor to: determine whether the input selecting the first key is a single tap gesture within the first key or a combination comprising a first tap gesture within the first key and a second tap gesture within the first key; and responsive to determining that the input selecting the first key is the combination comprising the first tap gesture within the first key and the second tap gesture within the first key, output, for display, the first character and the second character.

Clause 22. The computer-readable storage medium of any combination of clauses 19-21, wherein the instructions, when executed, further cause the at least one processor to: responsive to determining that the input selecting the first key is the single tap gesture within the first key, output, for display, the first character.

Clause 23. The computer-readable storage medium of any combination of clauses 19-22, wherein the instructions, when executed, further cause the at least one processor to: determine whether the input selecting the first key is a swipe gesture within the first key that moves towards the graphical indication of the second character; and responsive to determining that the input selecting the first key is the swipe gesture within the first key that moves towards the graphical indication of the second character, output, for display, the first character and the second character.

Clause 24. The computer-readable storage medium of any combination of clauses 19-23, wherein the instructions, when executed, further cause the at least one processor to: responsive to determining that the input selecting the first key is not the swipe gesture within the first key that moves towards the graphical indication of the second character, output, for display, the first character.

Clause 25. The computer-readable storage medium of any combination of clauses 19-24, wherein the instructions, when executed, further cause the at least one processor to: determine whether the input selecting the first key satisfies a pressure threshold; and responsive to determining that the input selecting the first key satisfies the pressure threshold, output, for display, the first character and the second character.

Clause 26. The computer-readable storage medium of any combination of clauses 19-25, wherein the instructions, when executed, further cause the at least one processor to: responsive to determining that the input selecting the first key does not satisfy the pressure threshold, output, for display, the first character.

Clause 27. The computer-readable storage medium of any combination of clauses 19-26, wherein the instructions, when executed, further cause the at least one processor to: responsive to determining that the score associated with the at least one candidate word does not satisfy the threshold: output, for display within the first key, the graphical indication of the first character; and refrain from outputting the graphical indication of the second graphical indication.

Clause 28. A computing device comprising means for performing the method of any combination of clauses 1-9.

Clause 29. A computer-readable storage medium encoded with instructions that, when executed, cause a computing device to perform the method of any combination of clauses 1-9.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media, which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used may refer to any of the foregoing structure or any other structure suitable for implementation of the techniques described. In addition, in some aspects, the functionality described may be provided within dedicated hardware and/or software modules. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

Various examples have been described. These and other examples are within the scope of the following claims.

1. A method comprising:
outputting, by a computing device, for display, a graphical keyboard comprising a plurality of keys, the plurality of keys including a first key that is associated with a first character;
determining, by the computing device, at least one candidate word that includes the first character;
determining, by the computing device, a score associated with the at least one candidate word that indicates a probability of the at least one candidate word being entered by one or more subsequent selections of one or more of the plurality of keys; and
responsive to determining that the score associated with the at least one candidate word satisfies a threshold:
determining, by the computing device, based on a spelling of the at least one candidate word, a second character of the at least one candidate word, wherein the second character immediately follows the first character in the spelling of the at least one candidate word; and
outputting, by the computing device, for display within the first key, a graphical indication of the first character and a graphical indication of the second character.

2. The method of claim 1, further comprising:
after outputting the graphical indication of the first character and the graphical indication of the second character, receiving, by the computing device, an input selecting the first key; and
determining, by the computing device, whether the input selecting the first key corresponds to the first character alone or to the first character followed by the second character.

3. The method of claim 2, further comprising:
determining, by the computing device, whether the input selecting the first key is a single tap gesture within the first key or a combination comprising a first tap gesture within the first key and a second tap gesture within the first key, and
responsive to determining that the input selecting the first key is the combination comprising the first tap gesture within the first key and the second tap gesture within the first key, outputting, by the computing device, for display, the first character and the second character.

4. The method of claim 3, further comprising:
responsive to determining that the input selecting the first key is the single tap gesture within the first key, outputting, by the computing device, for display, the first character.

5. The method of claim 2, further comprising:
determining, by the computing device, whether the input selecting the first key is a swipe gesture within the first key that moves towards the graphical indication of the second character; and
responsive to determining that the input selecting the first key is the swipe gesture within the first key that moves towards the graphical indication of the second character, outputting, by the computing device, for display, the first character and the second character.

6. The method of claim 5, further comprising:
responsive to determining that the input selecting the first key is not the swipe gesture within the first key that moves towards the graphical indication of the second character, outputting, by the computing device, for display, the first character.

7. The method of claim 2, further comprising:
determining, by the computing device, whether the input selecting the first key satisfies a pressure threshold; and
responsive to determining that the input selecting the first key satisfies the pressure threshold, outputting, by the computing device, for display, the first character and the second character.

8. The method of claim 7, further comprising:
responsive to determining that the input selecting the first key does not satisfy the pressure threshold, outputting, by the computing device, for display, the first character.

9. The method of claim 1, further comprising:
responsive to determining that the score associated with the at least one candidate word does not satisfy the threshold:
outputting, by the computing device, for display within the first key, the graphical indication of the first character; and
refraining from outputting, by the computing device, the graphical indication of the second graphical indication.

10. A computing device comprising:
a presence-sensitive display;
at least one processor; and
a memory that stores instructions that, when executed by the at least one processor, cause the at least one processor to:
output, for display at the presence-sensitive display, a graphical keyboard comprising a plurality of keys, the plurality of keys including a first key that is associated with a first character;
determine at least one candidate word that includes the first character;
determine a score associated with the at least one candidate word that indicates a probability of the at least one candidate word being entered by one or more subsequent selections of one or more of the plurality of keys; and
responsive to determining that the score associated with the at least one candidate word satisfies a threshold:
determine, based on a spelling of the at least one candidate word, a second character of the at least one candidate word, wherein the second character immediately follows the first character in the spelling of the at least one candidate word; and
output, for display within the first key, a graphical indication of the first character and a graphical indication of the second character.

11. The computing device of claim 10, wherein the instructions, when executed, cause the at least one processor to:
after outputting the graphical indication of the first character and the graphical indication of the second character, receive an input selecting the first key; and
determine whether the input selecting the first key corresponds to the first character alone or to the first character followed by the second character.

12. The computing device of claim 11, wherein the instructions, when executed, cause the at least one processor to:
determine whether the input selecting the first key is a single tap gesture within the first key or a combination comprising a first tap gesture within the first key and a second tap gesture within the first key; and
responsive to determining that the input selecting the first key is the combination comprising the first tap gesture within the first key and the second tap gesture within the first key, output, for display at the presence-sensitive display, the first character and the second character.

13. The computing device of claim 12, wherein the instructions, when executed, cause the at least one processor to:
responsive to determining that the input selecting the first key is the single tap gesture within the first key, output, for display at the presence-sensitive display, the first character.

14. The computing device of claim 11, wherein the instructions, when executed, cause the at least one processor to:
determine whether the input selecting the first key is a swipe gesture within the first key that moves towards the graphical indication of the second character; and
responsive to determining that the input selecting the first key is the swipe gesture within the first key that moves towards the graphical indication of the second character, output, for display at the presence-sensitive display, the first character and the second character.

15. The computing device of claim 14, wherein the instructions, when executed, cause the at least one processor to:
responsive to determining that the input selecting the first key is not the swipe gesture within the first key that moves towards the graphical indication of the second character, output, for display at the presence-sensitive display, the first character.

16. The computing device of claim 11, wherein the instructions, when executed, cause the at least one processor to:
determine whether the input selecting the first key satisfies a pressure threshold; and
responsive to determining that the input selecting the first key satisfies the pressure threshold, output, for display at the presence-sensitive display, the first character and the second character.

17. The computing device of claim 16, wherein the instructions, when executed, cause the at least one processor to:
responsive to determining that the input selecting the first key does not satisfy the pressure threshold, output, for display at the presence-sensitive display, the first character.

18. The computing device of claim 10, wherein the instructions, when executed, cause the at least one processor to:
responsive to determining that the score associated with the at least one candidate word does not satisfy the threshold:
output, for display within the first key, the graphical indication of the first character, and
refrain from outputting the graphical indication of the second graphical indication.

19. A computer-readable storage medium encoded with instructions that, when executed by at least one processor of a computing device, cause the at least one processor to:
output, for display, a graphical keyboard comprising a plurality of keys, the plurality of keys including a first key that is associated with a first character;
determine at least one candidate word that includes the first character;
determine a score associated with the at least one candidate word that indicates a probability of the at least one candidate word being entered by one or more subsequent selections of one or more of the plurality of keys; and
responsive to determining that the score associated with the at least one candidate word satisfies a threshold:
determine, based on a spelling of the at least one candidate word, a second character of the at least one candidate word, wherein the second character immediately follows the first character in the spelling of the at least one candidate word; and
output, for display within the first key, a graphical indication of the first character and a graphical indication of the second character.

20. The computer-readable storage medium of claim 19, wherein the instructions, when executed, further cause the at least one processor to:
after outputting the graphical indication of the first character and the graphical indication of the second character, receive an input selecting the first key; and
determine whether the input selecting the first key corresponds to the first character alone or to the first character followed by the second character.
